(19) United States
(12) Patent Application Publication
(10) Pub. No.: US 2006/0215567 A1
(43) Pub. Date: Sep. 28, 2006

(54) Method and apparatus for monitoring path statistics

(76) Inventors: Arun Raghunath, Beaverton, OR (US); Stephen D. Goglin, Hillsboro, OR (US); Erik J. Johnson, Portland, OR (US)

Correspondence Address: KACVINSKY LLC, 4500 BROOKTREE ROAD, SUITE 102, WEXFORD, PA, 15090, US

(21) Appl. No.: 11/090,571

(22) Filed: Mar. 25, 2005

(51) Int. Cl. H04L 12/56; H04L 12/26; H04L 12/28; H04J 1/16

(52) U.S. Cl. 370/241; 370/410

(57) ABSTRACT

A system, apparatus, method and article to monitor path statistics are described. The apparatus may include a channel implementation apparatus to implement one or more tagging channels and one or more counting channels along one or more paths capable of being traversed by a packet and a path counter to store path statistics associated with a path traversed by the packet according to a tag value associated with said packet. The tag value may be updated when the packet traverses a tagging channel, and the tag value may be read when the packet traverses a counting channel. Other embodiments are described and claimed.

### BACKGROUND

A packet processing system may implement a number of services such as Internet Protocol (IP) forwarding, Multiprotocol Label Switching (MPLS), Network Address Translation (NAT), and Virtual Private Network (VPN) services. Typically, only a subset of available services is active at a particular time. Processing resources can be utilized more efficiently if only active services are loaded onto processing devices suited to run them. As services become active they can be loaded onto a processing device and replace services that have become inactive. In order to adapt in this manner, service activity may be monitored at run time. Accordingly, there may be a need for improved techniques for monitoring service activity implemented by a system or within a network.

### BRIEF DESCRIPTION OF THE DRAWINGS

FIG. 1 illustrates a block diagram of a system in accordance with one embodiment.

FIG. 2 illustrates a logic diagram in accordance with one embodiment.

FIG. 3 illustrates a logic diagram in accordance with one embodiment.

FIGS. 4A-4M illustrate a block diagram of a system in accordance with one embodiment.

FIG. 5 illustrates a block diagram of a processing system in accordance with one embodiment.

### DETAILED DESCRIPTION

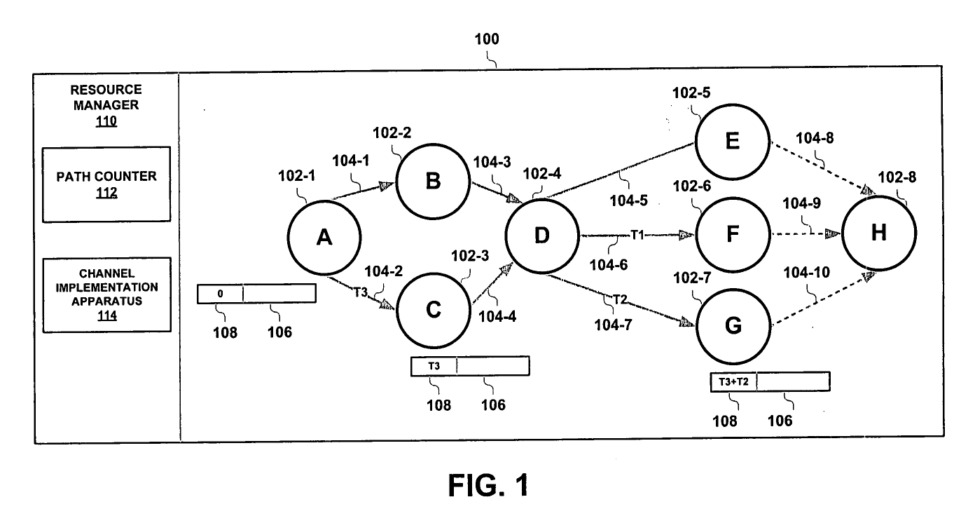

FIG. 1 illustrates a block diagram of a system 100. In one embodiment, for example, the system 100 may comprise a communication system having multiple nodes. A node may comprise any physical or logical entity for communicating information in the system 100 and may be implemented as hardware, software, or any combination thereof, as desired for a given set of design parameters or performance constraints.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

In various embodiments, a node may comprise, or be implemented as, a computer system, a computer sub-system, a computer, a workstation, a terminal, a server, a personal computer (PC), a laptop, an ultra-laptop, a handheld computer, a personal digital assistant (PDA), a set top box (STB), a telephone, a cellular telephone, a handset, an interface, an input/output (I/O) device (e.g., keyboard, mouse, display, printer), a router, a hub, a gateway, a bridge, a switch, a microprocessor, an integrated circuit, a programmable logic device (PLD), a digital signal processor (DSP), a processor, a circuit, a logic gate, a register, a microprocessor, an integrated circuit, a semiconductor device, a chip, a transistor, or any other device, machine, tool, equipment, component, or combination thereof. The embodiments are not limited in this context.

The nodes of the system 100 may comprise or form part of a network, such as a Local Area Network (LAN), a Metropolitan Area Network (MAN), a Wide Area Network (WAN), a Wireless LAN (WLAN), the Internet, the World Wide Web, a telephony network (e.g., analog, digital, wired, wireless, PSTN, ISDN, or xDSL), a radio network, a television network, a cable network, a satellite network, and/or any other wired or wireless communications network configured to carry data. The network may include one or more elements, such as, for example, intermediate nodes, proxy servers, firewalls, routers, switches, adapters, sockets, and wired or wireless data pathways, configured to direct and/or deliver data to other networks. The embodiments are not limited in this context.

The nodes of the system 100 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The embodiments are not limited in this context.

The nodes of system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth. For example, system 100 may comprise a packet network communicating information in accordance with one or more packet protocols, such as one or more Internet protocols, such as the Transport Control Protocol (TCP) and Internet Protocol (IP), TCP/IP, X.25, Hypertext Transfer Protocol (HTTP), and User Datagram Protocol (UDP). In another example, system 100 may communicate packets using a medium access control protocol such as Carrier-Sense Multiple Access with Collision Detection (CSMA/CD), as defined by one or more IEEE 802 Ethernet standards. In yet another example, system 100 may communicate packets in accordance with one or more Asynchronous Transfer Mode (ATM) protocols, Frame Relay, Systems Network Architecture (SNA), and so forth. The embodiments are not limited in this context.

As shown in FIG. 1, the system 100 may comprise nodes 102-1-n, where n represents any positive integer. Although FIG. 1 illustrates nodes 102-1 to 102-8 by way of example, it can be appreciated that more or less nodes may be employed for a given implementation. The nodes 102-1 to 102-8 generally may include various sources and/or destinations of information (e.g., media information, control information, image information, video information, audio information, or audio/video information). In various embodiments, the nodes 102-1 to 102-8 may originate from a number of different devices or networks. The embodiments are not limited in this context.

In various implementations, the nodes 102-1 to 102-8 may send and/or receive information through channels 104-1-n, where n represents any positive integer. FIG. 1 illustrates channels 104-1 to 104-10 by way of example. Channels 104-1 to 104-10 generally may comprise one or more types of communication media capable of carrying information. Communication media may include, for example, in-memory channels and/or inter-processor communication buses on a computer platform. Other examples may include wired communication media, wireless communication media, or a combination of both, as desired for a given implementation. The term “connected” and variations thereof, in this context, may refer to physical connections and/or logical connections. The embodiments are not limited in this context.

In various embodiments, the nodes 102-1 to 102-8 may interface with the channels 104-1 to 104- 10 through one or more ports. The ports generally may comprise any physical or logical interface of a node and may include one or more transmit ports, receive ports, and control ports for communicating data in a unidirectional or bidirectional manner between elements in the system 100. In various embodiments, the ports may comprise one or more data paths. Each data path may include information signals (e.g., data signals, a clock signal, a control signal, a parity signal, a status signal) and may be configured to use various signaling (e.g., low voltage differential signaling) and sampling techniques (e.g., both edges of clock). The embodiments are not limited in this context.

In various embodiments, the nodes 102-1 to 102-8 may be associated with one or more queues. In various implementations, a particular port or channel may be associated with a particular set of queues. A queue generally may comprise any type of data structure (e.g., array, file, table, record) capable of storing data. A queue may be implemented in hardware such as within a static random-access memory (SRAM) array. The SRAM array may comprise machine-readable storage devices and controllers, which are accessible by a processor and which are capable of storing a combination of computer program instructions and data. In various implementations, a controller may perform functions such as atomic read-modify-write operations (e.g., increment, decrement, add, subtract, bit-set, bit-clear, and swap), linked-list queue operations, and ring (e.g., circular buffer) operations. The embodiments are not limited in this context.

In other embodiments, a queue may comprise various types of storage media capable of storing packets and/or pointers to the storage locations of packets. Examples of storage media include read-only memory (ROM), random-access memory (RAM), dynamic RAM (DRAM), Double-Data-Rate DRAM (DDRAM), synchronous DRAM (SDRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic disk (e.g., floppy disk and hard drive), optical disk (e.g., CD-ROM), magnetic or optical cards, or any other type of media suitable for storing information. The embodiments are not limited in this context.

In various implementations, a queue may employ a first-in-first-out (FIFO) policy in which a queued packet may be sent only after all previously queued packets have been dequeued. A queue may be associated with a specific flow or class of packets, such as a group of packets having common header data or a common class of service. For example, a packet may be assigned to a particular flow based on its header data and then stored in a queue that corresponds to the flow. The embodiments are not limited in this context.

In various implementations, the nodes 102-1 to 102-8 may be arranged to perform one or more processing operations. Processing operations may generally refer to one or more operations, such as generating, managing, communicating, sending, receiving, storing forwarding, accessing, reading, writing, manipulating, encoding, decoding, compressing, decompressing, encrypting, filtering, streaming or other processing of information. The embodiments are not limited in this context.

In various implementations, one or more of the nodes 102-1 to 102-8 may be arranged to receive communications from, transmit communications to, and/or manage communications among nodes in the system 100. For example, one or more of the nodes 102-1 to 102-8 may perform ingress and egress processing operations such as receiving, classifying, metering, policing, buffering, scheduling, analyzing, segmenting, enqueuing, traffic shaping, dequeuing, and transmitting. The embodiments are not limited in this context.

In various embodiments, the nodes 102-1 to 102-8 may be arranged to communicate information in the form of packets, such as packet 106. For example, in general operation, the nodes 102-1 to 102-8 may communicate by segmenting a set of media information and control information into a series of packets. Each packet, such as packet 106, may contain a portion of the media information plus some control information and have a sequence number. The control information may assist various intermediate nodes to route each packet to its intended destination. A destination node may receive the entire set of packets, place them in the correct order using the sequence numbers, and reproduce the media information.

The packet 106 generally may comprise a discrete data set having fixed or varying lengths, and may be represented in terms of bits or bytes. A typical packet length, for example, might comprise 64 bytes. It can be appreciated that the described embodiments are applicable to any type of communication content or format, such as packets, cells, frames, fragments, units, and so forth. The embodiments are not limited in this context.

The packet 106 may be associated with metadata, such as metadata 108. The metadata 108 may comprise various types of data related to the packet 106. In various implementations, the metadata 108 may comprise header information such as one or more properties, attributes, values, text strings, handling information, routing information (e.g., source address, destination address, incoming port, outgoing port, next-hop identification), or other data associated with the packet 108.

In various embodiments, the metadata 108 may comprise a tag value associated with the packet 106. The tag value may comprise a number, such as a binary number represented by a sequence of bits. In various implementations, the tag value may comprise an added field to existing metadata 108 associated with the packet 106. The embodiments are not limited in this context.

In various embodiments, the system 100 may comprise a resource manager 110 arranged to dynamically allocate resources, assign various services to processing devices for execution, and collect and monitor service activity information. The resource manager 110 may include, for example, any suitable processing platform, computing platform, computing device, processing device, computing system, processing system, computer, processor, or the like, and may be implemented using any suitable combination of hardware and/or software. The embodiments are not limited in this context.

In various embodiments, the resource manager 110 may comprise a path counter 112. The path counter 112 may comprise any type of data storage capable of collecting and storing global path information. In various implementations, the path counter 112 may comprise an array of counters indexed by path identification (e.g., path_id) for tracking the number of packets that traverse each path. The path counter 112 may comprise, or be implemented as, any machine-readable or computer-readable storage media capable of storing data, including both volatile and non-volatile memory. Examples of storage media include ROM, RAM, SRAM, DRAM, DDRAM, SDRAM, PROM, EPROM, EEPROM, flash memory, polymer memory, SONOS memory, disk memory, or any other type of media suitable for storing information. The path counter 112 may contain various combinations of machine-readable storage devices through various controllers, which are accessible by a processor and which are capable of storing a combination of computer program instructions and data. The embodiments are not limited in this context.

In various embodiments, the resource manager 110 may comprise a channel implementation apparatus 114. The channel implementation apparatus 114 may be arranged to implement a framework for collecting and monitoring global path information, such as collecting path statistics and tracking packet traffic. The framework may comprise one or more tagging channels and one or more counting channels implemented between nodes. In various implementations, a tagging channel may comprise a communication channel arranged to associate a tag value with a packet, and a counting channel may comprise a communication channel arranged to read a tag value associated with a packet. The embodiments are not limited in this context.

The channel implementation apparatus 114 may be arranged to determine where to implement one or more tagging channels and where to implement one or more counting channels. In various embodiments, the channel implementation apparatus 114 may be arranged to perform a recursive depth-first traversal from a starting node to a leaf node through one or more child nodes. A starting node generally may refer to any node arranged to communicate information to one or more nodes, such as a source node or other beginning point in a data flow. A child node may refer to any node arranged to receive information from one or more nodes. A leaf node generally may refer to any node having no child nodes, such as a destination node or other terminating point in a data flow. In various implementations, counting channels may be allocated for the channels connecting to a leaf node to ensure that path statistics may be updated when a packet reaches the final stage of a data flow. The embodiments are not limited in this context.

In various embodiments, the channel implementation apparatus 114 may be arranged to allocate one or more tagging channels whenever a node has multiple child nodes. The channel implementation apparatus 114 may be arranged to determine a tag value for each tagging channel. The channel implementation apparatus 114 may track the paths that emanate from each starting node and each child node. The number of paths emanating from a child node may be used to determine a tag value to be associated with the next tagging channel to be implemented. The channel implementation apparatus 114 may determine tag values such that the sum of tag values along any path results in a globally unique value. The embodiments are not limited in this context.

In various embodiments, the channel implementation apparatus 114 may be arranged to minimize overhead required for path monitoring. For example, the channel implementation apparatus 114 may implement the minimum number of tagging channels and counting channels. Tagging channels may be implemented only where new subpaths can be created to ensure that every path is tracked while eliminating unnecessary metadata updates. In addition, the channel implementation apparatus 114 may generate path identifications contiguously starting from zero to use the least number of bits while ensuring unique path identifications. In addition, the use of contiguous path identifications enables path statistics to be indexed into an array without the need of a hashing function. The embodiments are not limited in this context.

As shown in FIG. 1, for example, the system 100 may comprise one or more tagging channels, such as tagging channels 104-2, 104-6 and 104-7 and one or more counting channels, such as counting channels 104-8, 104-9, and 104-10. For clarity and ease of understanding, the tagging channels are identified by a tag value (e.g., T1, T2, T3) and the counting channels are identified as broken lines.

In the embodiment of FIG. 1, for example, tagging channel 104-2 may connect node A 102-1 and node C 102-3 and may be arranged to add tagging value T3 to metadata 108 associated with packet 106. Tagging channel 104-6 may connect node D 102-4 and node F 102-6 and may be arranged to add tagging value T1 to metadata 108 associated with packet 106. Tagging channel 104-7 may connect node D 102-4 and node G 102-7 and may be arranged to add tagging value T2 to the metadata 108 associated with packet 106.

Counting channel 104-8 may connect node E 102-5 and node H 102-8 and may be arranged to read a tag value contained in metadata 108 of packet 106. Counting channel 104-9 may connect node F 102-6 and node H 102-8 and may be arranged to read a tag value contained in metadata 108 of packet 106. Counting channel 104-10 may connect node G 102-7 and node H 102-8 and may be arranged to read a tag value contained in metadata 108 of packet 106. When a tag value is read, path statistics may be updated in path counter 114, for example.

As shown in FIG. 1, the packet 106 may traverse six different paths to get from node A 102-1 to node H 102-8. Namely, path A-B-D-E-H (e.g., path_id=0), path A-B-D-F-H (e.g., path_id=1), path A-B-D-G-H (e.g., path_id=2), path A-C-D-E-H (e.g., path_id=3), path A-C-D-F-H (e.g., path_id=4), and path A-C-D-G-H (e.g., path_id=5). If the packet 106 traverses path A-C-D-G-H, the packet 106 travels through node A 102-1, node C 102-3, node D 102-4, node G 102-7, and node H 102-8, and over tagging channel 104-2, channel 104-4, tagging channel 104-7, and counting channel 104-10.

In one implementation, when the packet 106 traverses tagging channel 104-2, a tag value T3 is added to the metadata 108. When the packet 106 traverses channel 104-4, the metadata 108 is not updated. When the packet 106 traverses tagging channel 104-7, a tag value T2 is added to the metadata 108. When the packet 106 traverses the counting channel 104-10, the packet 106 contains a tag value of T3+T2 in metadata 108. If T2=2 and T3=3, the packet 106 may contain a tag value of 5, which may correspond to a path identification number (e.g., path_id=5) and indicate that the packet 106 traversed a particular path (e.g., path A-C-D-G-H). The embodiments are not limited in this context.

In various embodiments, the sum of the tag values along any path should result in a globally unique path value. For example, if T1=1, T2=2, and T3=3, packet 106 may have a tag value of 0 when path A-B-D-E-H (e.g., path_id=0) is traversed, a tag value of 1 when path A-B-D-F-H (e.g., path_id=1) is traversed, a tag value of 2 when path A-B-D-G-H (e.g., path_id=2) is traversed, a tag value of 3 when path A-C-D-E-H (e.g., path_id=3) is traversed, a tag value of 4 when path A-C-D-F-H (e.g., path_id=4) is traversed, and a tag value of 5 when path A-C-D-G-H (e.g., path_id=5) is traversed. It is noted that each individual tag value does not need to be unique. The embodiments are not limited in this context.

In various implementations, the channel implementation apparatus 114 may facilitate traversal of packets along the path that receives the most traffic. For example, the channel implementation apparatus 114 may assign a path identification of 0 (e.g., path_id=0) to the most frequently used path. Referring to FIG. 1, for example, path A-B-D-E-H may be assigned path_id=0 as the most frequently used path. If the metadata 108 is initialized to 0, traversal of path A-B-D-E-H will require no updating of the metadata. Accordingly, the processing required to update the tag value may be avoided along the most frequently used path. The embodiments are not limited in this context.

Operations for the above systems, nodes, apparatus, elements, and/or subsystems may be further described with reference to the following figures and accompanying examples. Some of the figures may include programming logic. Although such figures presented herein may include a particular programming logic, it can be appreciated that the programming logic merely provides an example of how the general functionality as described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

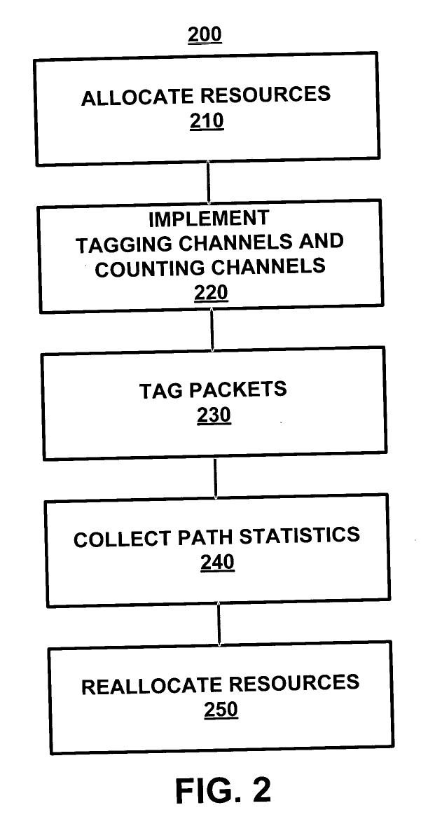

FIG. 2 illustrates a diagram of one embodiment of programming logic 200 for monitoring path information. In various implementations, the programming logic 200 may be performed by one or more elements of system 100 such as the resource manager 110 and/or the channel implementation apparatus 114, for example. It is to be understood that the programming logic 200 may be implemented by various other types of hardware, software, and/or combination thereof.

The programming logic 200 may comprise allocating resources (block 210). In various implementations, allocating resources may comprise distributing nodes within a system and allocating channels between nodes. In one embodiment, for example, the nodes may comprise various hardware, software, and/or combination thereof for packet processing. The embodiments are not limited in this context.

The programming logic 200 may comprise implementing tagging channels and counting channels (block 220). In various implementations, one or more channels may be implemented between nodes as tagging channels, and one or more channels may be implemented between nodes as counting channels. The tagging channels may comprise communication channels arranged to associate a tag value with a packet.

The counting channels may comprise communication channels arranged to read a tag value associated with a packet. In various embodiments, the implementations of tagging channels and counting channels may perform substantially independently from each other as well as from other components in the system.

The programming logic 200 may comprise tagging packets (block 230). In various implementations, a packet may traverse a path comprising multiple nodes and channels and may be tagged to identify a particular path taken by the packet. In various embodiments, a tag value associated with a packet may be updated in the event the packet traverses a tagging channel. The tag value may be contained in metadata associated with the packet and may be updated by hardware (e.g., processor), software (e.g., programming logic, library call), and/or combination thereof, for example.

In various implementations, the tag value may be updated prior to, after, or during traversal of the packet across the tagging channel. In various embodiments, a tag value may be updated locally at a particular node. For example, a node may be arranged to update a tag value locally when enqueuing a packet for transmission across a tagging channel or when receiving a packet across a tagging channel.

The programming logic 200 may comprise collecting path statistics (block 240). In various implementations, collecting path statistics may comprise obtaining global path information including the path traversed by a packet. In various embodiments, path statistics may be collected and monitored at run time in substantially real-time.

In various implementations, path statistics may be collected by reading a tag value associated with a packet in the event the packet traverses a counting channel. Collecting path statistics may include identifying a particular path based on the tag value and incrementing a path counter associated with the particular path to reflect the traversal of a packet. The embodiments are not limited in this context.

In various embodiments, the computation of a path identification value for the global path of a packet may be distributed among various nodes and/or channels. For example, the tag values for the tagging channels may be distributed in such a manner that when a packet traverses a particular path, the sum of the tag values automatically identifies the path counter to increment. In various embodiments, the sum of tag values along any given path results in a globally unique path identification value. Such distribution may enable the collection of global path information (e.g., the path traversed by a packet) by performing local monitoring (e.g., local tag updates). This ability to collect global information at run time by performing local monitoring may minimize the processing needed to compute the path at run time and improve efficiency. The embodiments are not limited in this context.

The programming logic may comprise reallocating resources (block 250). In various embodiments, collecting and monitoring path statistics may be used to effectuate an intelligent change in a system. In various implementations, reallocating resources may comprise adapting service activity to improve efficiency. For example, services may be intelligently mapped or remapped onto various processing devices for execution. In one embodiment, reallocating resources may comprise placing more efficient but scarce channel implementations on paths experiencing more traffic. In another embodiment, reallocating resources may comprise adapting to changing traffic conditions so that the most frequently used path in a system has the least overhead.

In various implementations, reallocating resources may comprise performing graceful degradation during overload conditions. For example, packets that cannot be processed on time may be dropped at the beginning of a path to avoid unnecessary processing. Reallocating resources may comprise providing service guarantees. For example, if path statistics indicate a service guarantee might not be met, the scheduling priority of nodes processing packets in a path may be increased. Reallocating resources may comprise responding to denial of service attacks. For example, uncharacteristically high amounts of traffic along a path might indicate a possible attack triggering policies to drop packets at the beginning of a path to prevent overflow of downstream queues shared by other traffic. The embodiments are not limited in this context.

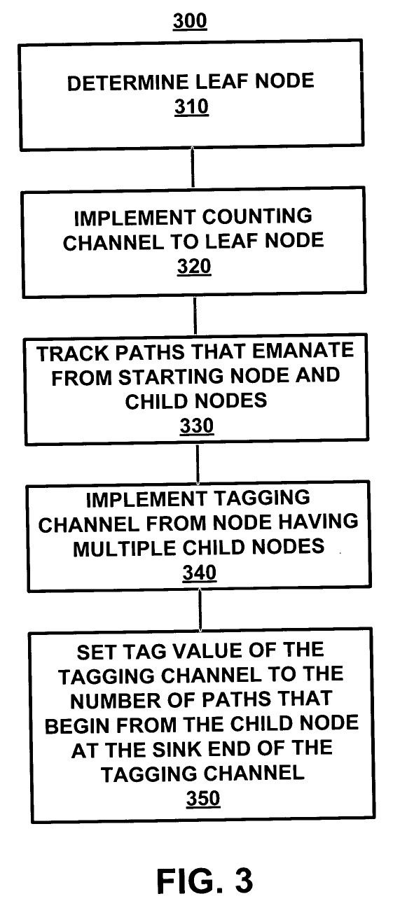

FIG. 3 illustrates a diagram of one embodiment of programming logic 300 for managing resources. In various embodiments, the programming logic 300 may comprise implementing a framework to monitor global path information. In various implementations, the programming logic 300 may comprise determining where to implement one or more tagging channels and where to implement one or more counting channels. The programming logic may comprise determining a leaf node (block 310). For example, the programming logic 300 may determine a leaf node by performing a recursive depth-first traversal from a starting node to a leaf node through one or more child nodes. The programming logic 300 may comprise implementing a counting channel to a leaf node (block 320). The embodiments are not limited in this context.

In various implementations, the programming logic 300 may track the paths that emanate from each starting node and each child node (block 330). In various implementations, the programming logic 300 may allocate one or more tagging channels whenever a node has multiple child nodes (block 340). The programming logic 300 may comprise determining a tag value for each tagging channel. The number of paths emanating from a child node may be used to determine a tag value to be associated with the next tagging channel to be implemented. The programming logic 300 may comprise setting the tag value of the tagging channel to the number of paths that begin from the child node at the sink end of the tagging channel (block 350). The programming logic 300 may be performed periodically to adapt to changing traffic patterns. The embodiments are not limited in this context.

One embodiment of an algorithm/pseudo-code for resource allocation is shown below:

```
find_paths(node)
{
    num_subpaths = 0;
    foreach channel in node.output_channel_list
    {
        if (num_subpaths != 0)
        {
            channel.type(TAGGING_CHANNEL);
            channel.tag_value(num_subpaths);
          }
        child = channel.sink( );
        if (child.visited( ) == FALSE)
        {
            find_paths(child);
            if(child.count( ) == 0) //leaf node
                channel.type(COUNTING_CHANNEL);
        }
        if (child.count( ) == 0)
            num_subpaths += 1;
        else
            num_subpaths += child.count( );
    }
    node.count(num_subpaths);
    node.visited(TRUE);
}
```

In various embodiments, the algorithm/pseudo-code may comprise a recursive function called from a starting node for output channels emanating from the starting node. The embodiments are not limited in this context.

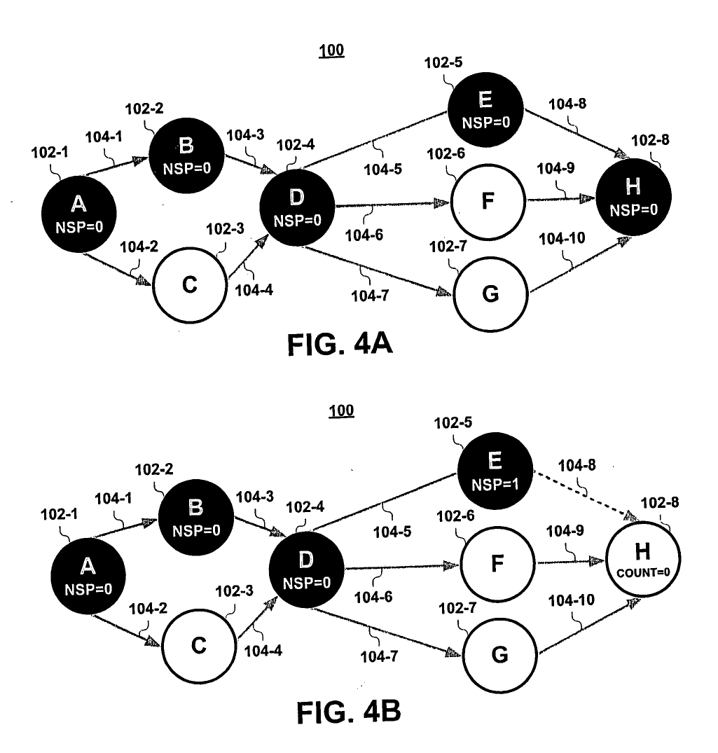

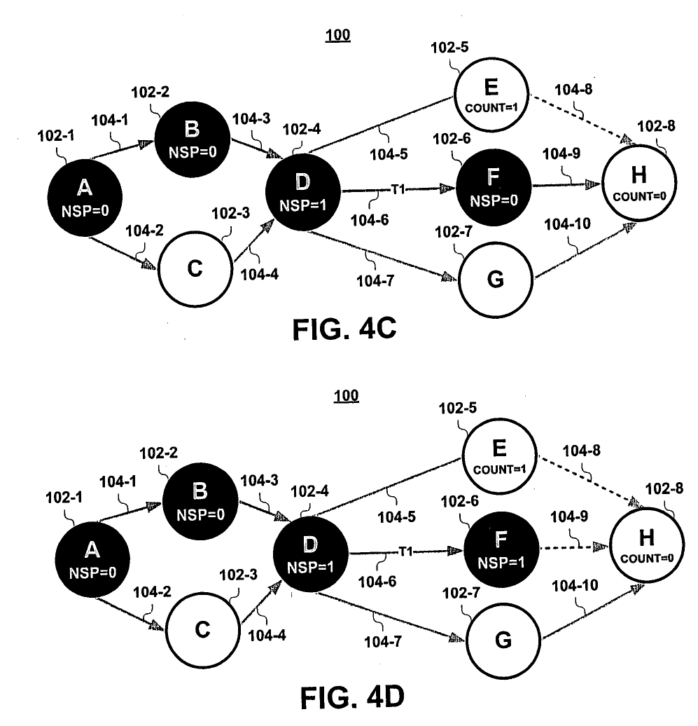

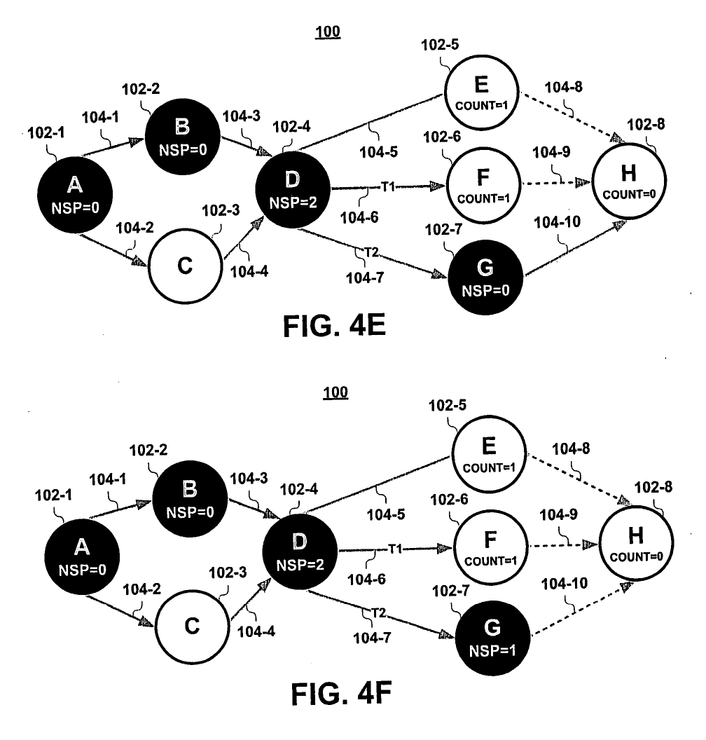

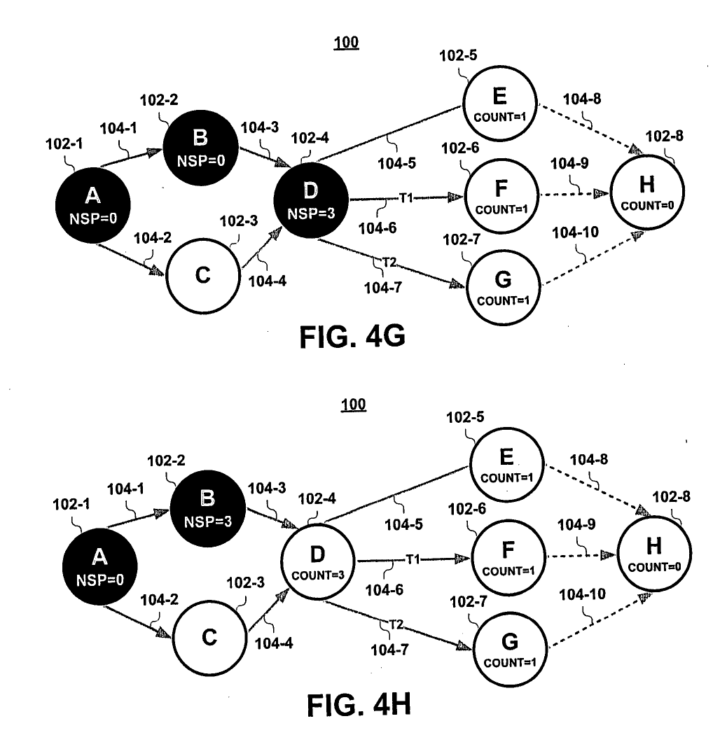

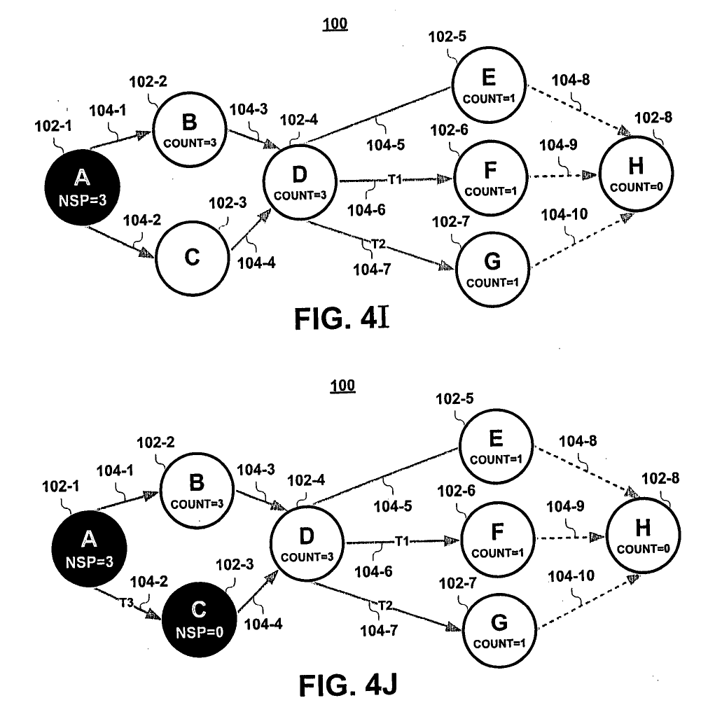

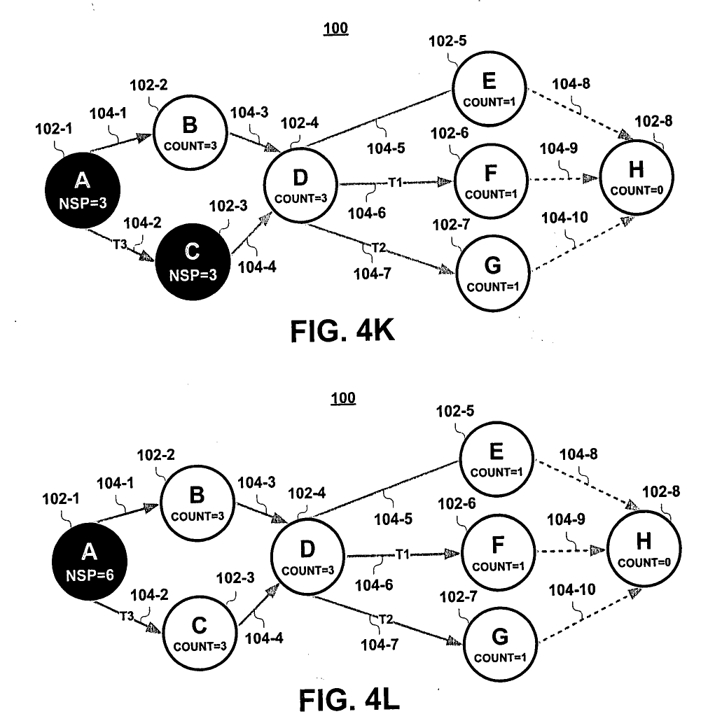

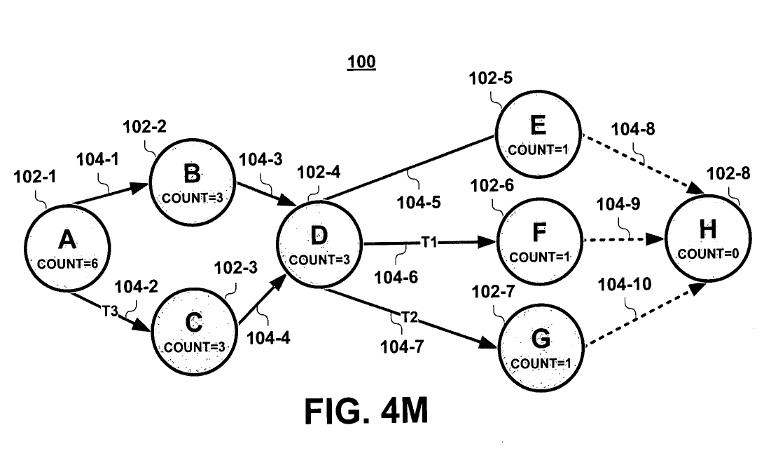

FIGS. 4A-4K illustrate one embodiment of performing programming logic 300 in accordance with an exemplary system 100. It is to be understood that while reference may be made to FIGS. 4A-4K, the programming logic 300 may be implemented by various types of hardware, software, and/or combination thereof.

Referring to 4A-4K, the programming logic 300 may comprise visiting a node and initializing a number of subpaths associated with the node. The number of subpaths may be initialized, for example, by setting a number of subpaths (NSP) value associated with the node to zero (e.g., NSP=0).

The programming logic 300 may comprise making a determination whether the node has one or more child nodes and, if so, whether there are unvisited child nodes. In the event that there are unvisited child nodes, a child node may be visited, a NSP value associated with the child node initialized, and a determination made whether the child node has one or more child nodes. In various implementations, the operations may be performed as a depth-first traversal of nodes to reach a leaf node having no child nodes. Referring to FIG. 4A, for example, starting node A 102-1, child node B 102-2, child node D 102-4, child node E 102-5, and leaf node H 102-8 may comprise visited nodes having an initialized NSP value (e.g., NSP=0).

The programming logic 300 may comprise setting a child count associated with a leaf node to zero. Referring to FIG. 4B, for example, a child count value (COUNT) associated with leaf node H 102-8 may be set to zero (e.g., COUNT=0).

The programming logic 300 may comprise implementing a counting channel. In various implementations, a counting channel may be allocated between a leaf node and the node feeding into the leaf node. Referring to FIG. 4B, for example, counting channel 104-8 may be implemented between leaf node H 102-8 and node E 102-5.

The programming logic 300 may comprise visiting a prior node and incrementing the subpaths associated with the node. For example, a NSP value associated with the prior node may be incremented. As shown in FIG. 4B, for example, the NSP value associated with node E 102-5 may be incremented to one (e.g., NSP=1).

The programming logic 300 may comprise making a determination whether the prior node has one or more unvisited child nodes and, in the event that there are no unvisited child nodes, setting a child count to the number of subpaths. Referring to FIG. 4C, for example, node E 102-5 has no unvisited child nodes. Accordingly, the child count value for node E 102-5 may be set to the number of subpaths (e.g., COUNT=NSP=1).

In the event that the current node is not the starting node, the programming logic 300 may comprise visiting a prior node and incrementing the subpaths associated with the prior node. Referring to FIG. 4C, for example, node E 102-5 is not the starting node. Accordingly, prior node D 102-4 may be visited and the associated NSP value incremented by the number of subpaths starting from the current node (e.g., NSP=1).

At the prior node, a determination may be made whether there are any unvisited child nodes. In the event that there are unvisited child nodes, the programming logic 300 may comprise implementing a tagging channel. Referring to FIG. 4C, for example, node D 102-4 has multiple child nodes including visited child node E 102-5, unvisited child node F 102-6, and unvisited child node G 102-7. A tagging channel 104-6 may be implemented between node D 102-4 and child node F 102-6 and a tag value T1 may be assigned to the tagging channel 104-6. The tag value T1 may be set to the number of subpaths associated with node D 102-4 (e.g., T1=NSP=1).

The child node may be visited, a NSP value associated with the child node initialized, and a determination made whether the child node has one or more child nodes. Referring to FIG. 4C, child node F 102-6 may be visited, an associated NSP may be initialized (e.g., NSP=0), and node H 102-8 may comprise a child node of node F 102-6.

In the event that a visited child node is a leaf node, the programming logic 300 may comprise implementing a counting channel and incrementing subpaths associated. Referring to FIG. 4D, for example, a counting channel 104-9 may be implemented between node F 102-6 and visited leaf node H 102-8. The number of subpaths associated with node F 102-6 may be incremented from zero to one (e.g., NSP=1).

In the event that there are no unvisited child nodes, a child count may be set to the number of subpaths. Referring to FIG. 4E, for example, node F 102-6 has no unvisited child nodes. Accordingly, the child count value for node F 102-6 may be set to the number of subpaths (COUNT=NSP=1).

In the event that the current node is not the starting node, a prior node may be visited and the subpaths associated with the prior node may be incremented. Referring to FIG. 4E, for example, node F 102-5 is not the starting node. Accordingly, prior node D 102-4 may be visited and the associated NSP value incremented by the number of subpaths starting from the current node (e.g., NSP=2).

At the prior node, a tagging channel may be implemented in the event that there are unvisited child nodes. Referring to FIG. 4E, for example, node D 102-4 has multiple child nodes including visited child node E 102-5, visited child node F 102-6, and unvisited child node G 102-7. A tagging channel 104-7 may be implemented between node D 102-4 and child node G 102-7 and a tag value T2 may be assigned to the tagging channel 104-7. The tag value T2 may be set to the number of subpaths associated with node D 102-4 (e.g., T2=NSP=2).

The child node may be visited, a NSP value associated with the child node initialized, and a determination made whether the child node has one or more child nodes. Referring to FIG. 4E, child node G 102-7 may be visited, an associated NSP may be initialized (e.g., NSP=0), and node H 102-8 may comprise a child node of node G 102-7.

In the event that a visited child node is a leaf node, a counting channel may be implemented and the subpaths associated with the node may be incremented. Referring to FIG. 4F, for example, a counting channel 104-10 may be implemented between node G 102-7 and visited leaf node H 102-8. The number of subpaths associated with node G 102-7 may be incremented from zero to one (e.g., NSP=1).

In the event that there are no unvisited child nodes, a child count may be set to the number of subpaths. Referring to FIG. 4G, for example, node G 102-7 has no unvisited child nodes. Accordingly, the child count value for node G 102-7 may be set to the number of subpaths (COUNT=NSP=1).

In the event that the current node is not the starting node, a prior node may be visited and the subpaths associated with the prior node may be incremented. Referring to FIG. 4G, for example, node G 102-7 is not the starting node. Accordingly, prior node D 102-4 may be visited and the associated NSP value incremented by the number of subpaths starting from the current node (e.g., NSP=3).

In the event that there are no unvisited child nodes, a child count may be set to the number of subpaths. Referring to FIG. 4H, for example, node D 102-4 has no unvisited child nodes. Accordingly, the child count value for node D 102-4 may be set to the number of subpaths (COUNT=NSP=3).

In the event that the current node is not the starting node, a prior node may be visited and the subpaths associated with the prior node may be incremented. Referring to FIG. 4H, for example, node D 102-4 is not the starting node. Accordingly, prior node B 102-2 may be visited and the associated NSP value incremented by the number of subpaths starting from the current node(e.g., NSP=3).

In the event that there are no unvisited child nodes, a child count may be set to the number of subpaths. Referring to FIG. 41, for example, node B 102-2 has no unvisited child nodes. Accordingly, the child count value for node B 102-2 may be set to the number of subpaths (COUNT=NSP=3).

In the event that the current node is not the starting node, a prior node may be visited and the subpaths associated with the prior node may be incremented. Referring to FIG. 4J, for example, node B 102-2 is not the starting node. Accordingly, prior node A 102-1 may be visited and the associated NSP value incremented by the number of subpaths starting from the current node (e.g., NSP=3).

At the prior node, a tagging channel may be implemented in the event that there are unvisited child nodes. Referring to FIG. 4J, for example, node A 102-1 has multiple child nodes including visited child node B 102-2 and unvisited child node C 102-3. A tagging channel 104-2 may be implemented between node A 102-1 and child node C 102-3 and a tag value T3 may be assigned to the tagging channel 104-2. The tag value T3 may be set to the number of subpaths associated with node A 102-1 (e.g., T3=NSP=3).

The child node may be visited, a NSP value associated with the child node initialized, and a determination made whether the child node has one or more child nodes. Referring to FIG. 4J, child node C 102-3 may be visited, an associated NSP may be initialized (e.g., NSP=0), and node D 102-4 may comprise a child node of node C 102-3.

In the event that a visited child node is not a leaf node, the subpaths associated with the current node may be incremented. Referring to FIG. 4K, for example, visited node D 102-4 is not a leaf node, and the number of subpaths associated with node C 102-3 may be incremented by the number of subpaths starting from child node D (e.g., NSP=3).

In the event that there are no unvisited child nodes, a child count may be set to the number of subpaths. Referring to FIG. 4L, for example, node C 102-3 has no unvisited child nodes. Accordingly, the child count value for node C 102-3 may be set to the number of subpaths (COUNT=NSP=3).

In the event that the current node is not the starting node, a prior node may be visited and the subpaths associated with the prior node may be incremented. Referring to FIG. 4L, for example, node C 102-3 is not the starting node. Accordingly, prior node A 102-1 may be visited and the associated NSP value incremented by the number of subpaths starting from the child node C(e.g., NSP=6).

In the event that there are no unvisited child nodes, a child count may be set to the number of subpaths. Referring to FIG. 4M, for example, node A 102-1 has no unvisited child nodes. Accordingly, the child count value for node A 102-1 may be set to the number of subpaths (COUNT=NSP=6).

In the event that the current node is the starting node, the programming logic 300 may end or restart. Referring to FIG. 4M, for example, node A 102-1 is the starting node.

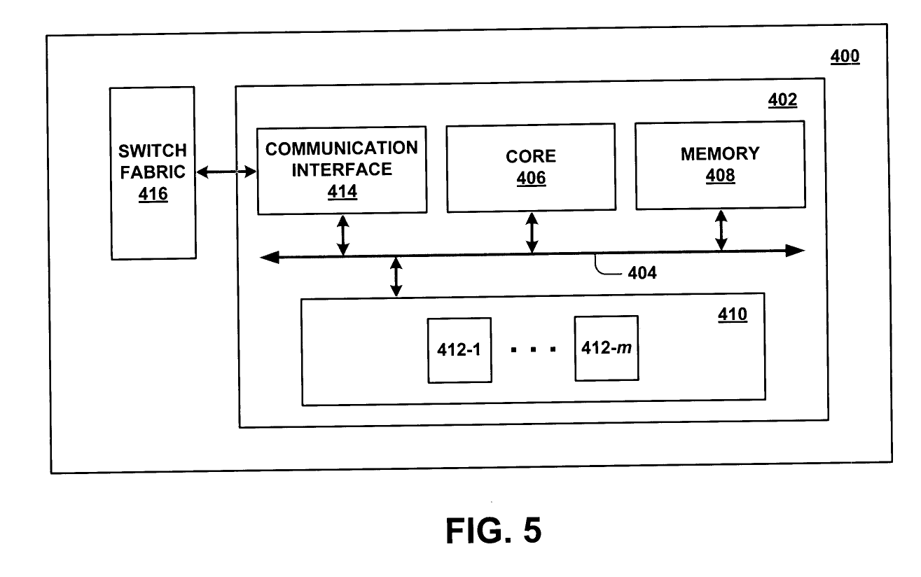

FIG. 5 illustrates one embodiment of a processing system 400. In various implementations, the processing system 400 may be arranged to perform various packet processing operations. It is to be understood that the illustrated processing system 400 is an exemplary embodiment and may include additional components, which have been omitted for clarity and ease of understanding.

The processing system 400 may comprise a processing apparatus 402. In various embodiments, the processing apparatus 402 may comprise a chip multiprocessor (CMP), such as a network processor, for example. A network processor may comprise a processor designed specifically for packet processing, a core element in high-speed communications routers and switches. Similar in some ways to a general purpose processor, a network processor is a programmable chip. The instruction set for the network processor, however, has been optimized to support the operations needed in networking, particularly for packet processing. Network processors therefore provide the programmability of a general purpose processor, with the speed of a dedicated custom hardware, such as an Application Specific Integrated Circuit (ASIC).

The processing apparatus 402 may comprise a bus 404 to which various functional units may be coupled. In various implementations, the bus 404 may comprise a collection of one or more on-chip buses that interconnect the various functional units of the processing apparatus 402. Although the bus 404 is depicted as a single bus for ease of understanding, it may be appreciated that the bus 404 may comprise any bus architecture and may include any number and combination of buses. The embodiments are not limited in this context.

The processing apparatus 402 may comprise a core 406 having access to various functional units and resources. In one embodiment, for example, the core 406 may be implemented as an XScale® based architecture by Intel® Corporation of Santa Clara, Calif. In other embodiments, the core 406 may comprise any suitable type of processor such as a general purpose processor, a dedicated processor, such as a controller, micro-controller, embedded processor, a digital signal processor (DSP), a field programmable gate array (FPGA), a programmable logic device (PLD), a network processor, an I/O processor, and so forth.

In various implementations, the core 406 may be arranged to execute an operating system (OS) and control operation of the processing apparatus 402. In one embodiment, for example, the core 406 may be implemented using an OS such as VXWorks from Wind River International of Alameda, Calif., μC/OS from Micrium, Inc. of Weston, Fla., and so forth. The core 406 may perform various processing operations such as performing management task, dispensing instructions, and handling exception packets. The embodiments are not limited in this context.

The processing apparatus 402 may comprise a memory 408. In various embodiments, the memory 408 may comprise, or be implemented as, any machine-readable or computer-readable storage media capable of storing data, including both volatile and non-volatile memory. Examples of storage media include ROM, RAM, SRAM, DRAM, DDRAM, SDRAM, PROM, EPROM, EEPROM, flash memory, polymer memory, SONOS memory, disk memory, or any other type of media suitable for storing information. The memory 408 may contain various combinations of machine-readable storage devices through various controllers, which are accessible by a processor and which are capable of storing a combination of computer program instructions and data. The embodiments are not limited in this context.

The processing apparatus 402 may comprise a processing engine cluster 410 including a number of processing engines, such as processing engines 412-1-m, where m represents any positive integer. In one embodiment, the processing apparatus 402 may comprise two clusters of eight processing engines. In various embodiments, each of the processing engines 412-1-m may comprise a processing system arranged to execute programming logic (e.g., micro-blocks running on a thread of a micro-engine). The processing engines 412-1-m may comprise, for example, an arithmetic and logic unit (ALU), a controller, and a number of registers (e.g., general purpose, SRAM transfer, DRAM transfer, next-neighbor). In various implementations, the processing engines 412-1-m may provide for multiple threads of execution (e.g., four, eight). The processing engines 412-1-m may include a local memory (e.g., SRAM, ROM, EPROM, flash memory) that may be used to store instructions for execution. The embodiments are not limited in this context.

The processing device 402 may comprise a communication interface 414 coupled with the bus 404. The communication interface 414 may comprises any suitable hardware, software, or combination of hardware and software that is capable of coupling the processing apparatus to one or more networks and/or network devices. In various embodiments, the communication interface 414 may comprise one or more interfaces such as, for example, a transmit interface, a receive interface, a Media and Switch Fabric (MSF) Interface, a System Packet Interface (SPI), a Common Switch Interface (CSI), a Peripheral Component Interface (PCI), a Small Computer System Interface (SCSI), an Internet Exchange (IE) interface, a Fabric Interface Chip (FIC), a line card, a port, or any other suitable interface. The embodiments are not limited in this context.

In various implementations, the communication interface 414 may be arranged to connect the processing apparatus 402 to one or more physical layer devices and/or a switch fabric 416. The processing apparatus 402 may provide an interface between a network and the switch fabric 416. The processing apparatus 402 may perform various processing on the data, such as converting data into a transmission format for transmission across the switch fabric 110. The processing apparatus 402 may receive data from the switch fabric 416, process the data, and convert the data into a network format (e.g., ATM ). The embodiments are not limited in this context.

In various implementations, the described embodiments may be implemented by a processing systems such as the Intel® IXP2400 network processor, the Intel® IXP2800 network processor, the Intel® Software Development Kit (SDK), the Intel® Internet Exchange Architecture (IXA), and or any multi-core architecture.

It is to be understood that the described embodiments are not limited in application and may be applicable to various devices, systems, and/or operations involving packet processing. For example, the described embodiments may be implemented in a switch on a high speed backplane fabric in some implementations.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although a system may be illustrated using a particular communications media by way of example, it may be appreciated that the principles and techniques discussed herein may be implemented using any type of communication media and accompanying technology. For example, a system may be implemented as a wired communication system, a wireless communication system, or a combination of both.

When implemented as a wireless system, for example, a system may include one or more wireless nodes arranged to communicate information over one or more types of wireless communication media. An example of a wireless communication media may include portions of a wireless spectrum, such as the radio-frequency (RF) spectrum and so forth. The wireless nodes may include components and interfaces suitable for communicating information signals over the designated wireless spectrum, such as one or more antennas, wireless transmitters/receivers (“transceivers”), amplifiers, filters, control logic, and so forth. As used herein, the term “transceiver” may be used in a very general sense to include a transmitter, a receiver, or a combination of both. Examples for the antenna may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. The embodiments are not limited in this context.

When implemented as a wired system, for example, a system may include one or more nodes arranged to communicate information over one or more wired communications media. Examples of wired communications media may include a wire, cable, metal leads, printed circuit board (PCB), backplane, switch fabric, semiconductor material, twisted-pair wire, co-axial cable, fiber optics, and so forth. The embodiments are not limited in this context.

In various embodiments, communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an ASIC, PLD, DSP, and so forth. In yet another example, an embodiment may be implemented by any combination of programmed general-purpose computer components and custom hardware components. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a channel implementation apparatus to implement one or more tagging channels and one or more counting channels along one or more paths capable of being traversed by a packet; and
a path counter to store path statistics associated with a path traversed by said packet according to a tag value associated with said packet, wherein
said tag value is updated when said packet traverses a tagging channel, and
said tag value is read when said packet traverses a counting channel.

2. The apparatus of claim 1, wherein said channel implementation apparatus is to implement a tagging channel from a node having multiple child nodes.

3. The apparatus of claim 1, wherein said channel implementation apparatus is to implement a counting channel to a leaf node having no child nodes.

4. The apparatus of claim 1, wherein said tag value is to identify a particular path traversed by said packet.

5. The apparatus of claim 1, wherein said tag value comprises a sum of tag values.

6. A system, comprising:
a switch fabric;
a processing apparatus to couple to said switch fabric, said processing apparatus comprising:
a channel implementation apparatus to implement one or more tagging channels and one or more counting channels along one or more paths capable of being traversed by a packet; and
a path counter to store path statistics associated with a path traversed by said packet according to a tag value associated with said packet, wherein
said tag value is updated when said packet traverses a tagging channel, and
said tag value is read when said packet traverses a counting channel.

7. The system of claim 6, wherein said channel implementation apparatus is to implement a tagging channel from a node having multiple child nodes.

8. The system of claim 6, wherein said channel implementation apparatus is to implement a counting channel to a leaf node having no child nodes.

9. The system of claim 6, wherein said tag value is to identify a particular path traversed by said packet.

10. The system of claim 6, wherein said wherein said tag value comprises a sum of tag values.

11. A method, comprising:
implementing one or more tagging channels and one or more counting channels along one or more paths capable of being traversed by a packet; and
storing path statistics associated with a path traversed by said packet according to a tag value associated with said packet, wherein
said tag value is updated when said packet traverses a tagging channel, and
said tag value is read when said packet traverses a counting channel.

12. The method of claim 11, further comprising implementing a tagging channel from a node having multiple child nodes.

13. The method of claim 11, further comprising implementing a counting channel to a leaf node having no child nodes.

14. The method of claim 11, further comprising identifying a particular path traversed by said packet based on said tag value.

15. The method of claim 14, wherein said tag value comprises a sum of tag values.

16. The method of claim 11, further comprising generating tag values for said tagging channels.

17. The method of claim 16, wherein summation of tag values along a particular path results in a unique number for said particular path.

18. The method of claim 16, wherein said tag values uniquely identify all paths capable of being traversed by said packet using a minimum number of tagging channels.

19. The method of claim 16, further comprising modifying said tag values at run time to reduce overhead of determining a path identification for a path experiencing the most traffic.

20. The method of claim 11, further comprising determining global information comprising a path traversed by said packet by local monitoring only.

21. An article comprising a machine-readable storage medium containing instructions that if executed enable a system to:
implement one or more tagging channels and one or more counting channels along one or more paths capable of being traversed by a packet; and
store path statistics associated with a path traversed by said packet according to a tag value associated with said packet, wherein
said tag value is updated when said packet traverses a tagging channel, and
said tag value is read when said packet traverses a counting channel.

22. The article of claim 21, further comprising instructions that if executed enable the system to implement a tagging channel from a node having multiple child nodes.

23. The article of claim 21, further comprising instructions that if executed enable the system to implement a counting channel to a leaf node having no child nodes.

24. The article of claim 21, further comprising instructions that if executed enable the system to identify a particular path traversed by said packet based on said tag value.

25. The article of claim 21, wherein said tag value comprises a sum of tag values.
